(19) United States
(12) Patent Application Publication
(10) Pub. No.: US 2024/0158616 A1
(43) Pub. Date: May 16, 2024

(54) PLANT FILLER-CONTAINING COMPOSITE RESIN COMPOSITION AND COMPOSITE RESIN MOLDED ARTICLE USING PLANT FILLER-CONTAINING COMPOSITE RESIN COMPOSITION

(71) Applicant: Panasonic Intellectual Property Management Co., Ltd., Osaka (JP)

(72) Inventors: MASAYOSHI IMANISHI, Osaka (JP); MASASHI HAMABE, Osaka (JP); TOSHIFUMI NAGINO, Osaka (JP); SHOUMA NISHINO, Fukui (JP)

(21) Appl. No.: 18/423,886

(22) Filed: Jan. 26, 2024

Related U.S. Application Data
(63) Continuation of application No. PCT/JP2022/023712, filed on Jun. 14, 2022.

(30) Foreign Application Priority Data
Aug. 5, 2021 (JP) 2021-129273

(51) Int. Cl. C08K 11/00; C08L 23/12

(52) U.S. Cl. CPC C08K 11/00; C08L 23/12; C08K 2201/005

(57) ABSTRACT

A plant filler-containing composite resin composition contains: a base resin; a plant filler dispersed in the base resin; and a dispersant dispersed in the base resin, in which from 50 mass % to 97 mass % inclusive of the plant filler is a first plant filler containing less than 1 mass % of triacylglycerol, from 3 mass % to 50 mass % inclusive of the plant filler is a second plant filler containing from 1 mass % to 40 mass % inclusive of triacylglycerol, and the base resin is a crystalline resin.

### TECHNICAL FIELD

The present disclosure relates to a plant filler-containing composite resin composition and a molded article using the plant filler-containing composite resin composition. In particular, the present disclosure relates to a composite resin composition containing a plant filler at a high concentration.

### BACKGROUND ART

So-called “general-purpose plastics” such as polyethylene (PE), polypropylene (PP), polystyrene (PS), and polyvinyl chloride (PVC) have characteristics of being relatively inexpensive, having a weight as small as a fraction of the weight of metal or ceramics, and being easy to process such as molding. Therefore, general-purpose plastics are used as materials of various daily commodities such as bags, various packaging, various containers, and sheets, and industrial components such as automobile components and electrical components, daily necessities, and miscellaneous goods.

However, general-purpose plastics have disadvantages such as insufficient mechanical strength. Therefore, general-purpose plastics do not have sufficient properties required for materials used for machine products such as automobiles and various industrial products including electric/electronic/information products, and the application range thereof is currently limited.

On the other hand, so-called “engineering plastics” such as polyacetal (POM), polyamide (PA), polycarbonate (PC), and fluororesin are excellent in mechanical properties, and are used for various industrial products including machine products such as automobiles, and electric/electronic/information products. However, engineering plastics have problems of being expensive, difficult to recycle monomers, and imposing a large environmental load.

Therefore, there has been a demand for greatly improving the material properties (mechanical strength and the like) of general-purpose plastics. As a method for improving the material properties of general-purpose plastics, a technique for producing a composite resin by blending two or more types of resins or additives such as fillers is known. In particular, natural fibers, glass fibers, carbon fibers, and the like, which are fibrous fillers, are used for the purpose of improving the mechanical strength. Among them, organic fibrous fillers such as cellulose have attracted attention in recent years as reinforcing fibers because they are inexpensive and excellent in environmental properties at the time of disposal.

As one of the applications of the composite resin, the composite resin is used for components such as housings of household electric appliances, and interior and exterior components of automobiles. As a molding method for preparing the components, a method such as injection molding or extrusion molding is used. The above molding methods enable high cycle production, but the material to be used needs to have high fluidity. However, as the addition amount of the filler increases, the mechanical strength such as the elastic modulus of the composite resin increases while the fluidity decreases. Therefore, the composite resin to which the filler is added at a high concentration has a feature of having low fluidity and being difficult to mold. In PTL 1, fluidity is improved by adding an ester-based plasticizer to a high-concentration filler composite resin, thereby improving moldability.

### CITATION LIST

### Patent Literature

PTL 1: Unexamined Japanese Patent Publication No. 2002-53758

### SUMMARY OF THE INVENTION

### Technical Problem

A plant filler-containing composite resin composition according to one aspect of the present disclosure contains: a base resin; a plant filler dispersed in the base resin; and a dispersant dispersed in the base resin, in which from 50 mass % to 97 mass % inclusive of the plant filler is a first plant filler containing less than 1 mass % of triacylglycerol, from 3 mass % to 50 mass % inclusive of the plant filler is a second plant filler containing from 1 mass % to 40 mass % inclusive of triacylglycerol, and the base resin is a crystalline resin.

### BRIEF DESCRIPTION OF THE DRAWINGS

FIG. 1 is a schematic view of a plant filler-containing composite resin composition according to the first exemplary embodiment.

FIG. 2 is a view showing conditions and measurement results in Examples 1 to 4 and Comparative Examples 1 to 5.

### DESCRIPTION OF EMBODIMENT

In the composite resin described in PTL 1, an ester-based plasticizer is used, but the plasticizer as a simple substance has a strength significantly lower than that of the base resin or the filler, and thus has a problem of reducing the mechanical strength such as the elastic modulus of the composite resin. In addition, the plasticizer has a low molecular weight, and thus has a problem of causing bleed-out on the surface of the pellet or the molded article, that is, a phenomenon that the plasticizer as an additive comes up to the surface of the molded article.

An object of the present disclosure is to provide a plant filler composite resin having high fluidity and high mechanical strength without separately adding a plasticizer.

A plant filler-containing composite resin composition according to the first aspect contains: a base resin; a plant filler dispersed in the base resin; and a dispersant dispersed in the base resin, in which from 50 mass % to 97 mass % inclusive of the plant filler is a first plant filler containing less than 1 mass % of triacylglycerol, from 3 mass % to 50 mass % inclusive of the plant filler is a second plant filler containing from 1 mass % to 40 mass % inclusive of triacylglycerol, and the base resin is a crystalline resin.

In the plant filler-containing composite resin composition according to the second aspect, in the first aspect, a content of the plant filler in the plant filler-containing composite resin composition may range from 50 mass % to 90 mass % inclusive when a total amount of the base resin, the plant filler, and the dispersant in the plant filler-containing composite resin composition is 100 mass %.

In the plant filler-containing composite resin composition according to the third aspect, in the first or second aspect, a total content of cellulose, hemicellulose, and lignin in the second plant filler may be from 5 mass % to 50 mass % inclusive.

In the plant filler-containing composite resin composition according to the fourth aspect, in any one of the first to third aspects, a total content of cellulose, hemicellulose, and lignin in the first plant filler may be more than or equal to 80 mass %.

In the plant filler-containing composite resin composition according to the fifth aspect, in any one of the first to fourth aspects, the plant filler may have an average particle size of from 100 nm to 3 mm inclusive.

In the plant filler-containing composite resin composition according to the sixth aspect, in any one of the first to fifth aspects, the base resin may have a degree of crystallinity of more than or equal to 30%.

In the plant filler-containing composite resin composition according to the seventh aspect, in any one of the first to sixth aspects, the base resin may include a first region around the plant filler and a second region away from the plant filler, and a degree of crystallinity of the base resin in the first region may be more than or equal to 1.05 times a degree of crystallinity of the base resin in the second region.

A composite resin molded article according to the eighth aspect contains the plant filler-containing composite resin composition according to any one of the first to seventh aspects.

The plant filler-containing composite resin composition according to the present disclosure contains from 3 mass % to 50 mass % inclusive of a second plant filler containing from 1 mass % to 40 mass % inclusive of triacylglycerol, with respect to the total amount of the plant filler. The plant filler-containing composite resin composition according to the present disclosure also contains from 50 mass % to 97 mass % inclusive of a first plant filler containing less than 1 mass % of triacylglycerol. For this reason, the plant filler-containing composite resin composition according to the present disclosure can have high fluidity while having high strength. Thus, a molding method having high mass productivity in a high cycle, such as injection molding or extrusion molding can be applied. In addition, since the crystalline resin is used for the base resin, the degree of crystallinity around the plant filler and the degree of crystallinity of the entire resin are increased, thereby making it possible suppress bleed-out of triacylglycerol. Therefore, a molded article using the plant filler-containing composite resin composition according to the present disclosure can be used as a molded article without any problem.

Hereinafter, a plant filler-containing composite resin composition in an exemplary embodiment and a molded article thereof will be described with reference to the accompanying drawings. Note that, in the following description, the same components are denoted by the same reference marks, and the description thereof is appropriately omitted.

### First Exemplary Embodiment

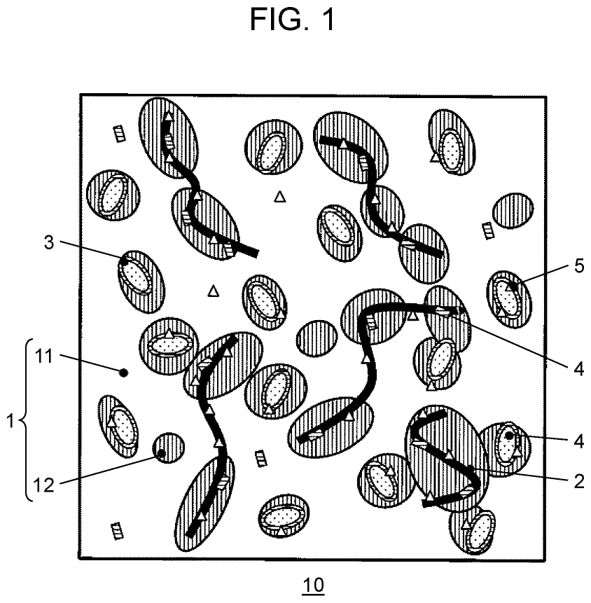

Plant filler-containing composite resin composition 10 according to the first exemplary embodiment contains base resin 1, first plant filler 2 represented by a black long string shape in FIG. 1, second plant filler 3 represented by an elliptical shape in FIG. 1, triacylglycerol 4 represented by a quadrangular shape in FIG. 1, and dispersant 5 represented by a triangular shape in FIG. 1. Base resin 1 contains a matrix of amorphous portion 11 and crystalline portion 12. As shown in FIG. 1, in plant filler-containing composite resin composition 10, first plant filler 2, second plant filler 3, triacylglycerol 4, and dispersant 5 are dispersed in the matrix of base resin 1. Triacylglycerol 4 may be present on the surface or inside of second plant filler 3, on the surface of first plant filler 2, in the matrix of base resin 1, and the like. Dispersant 5 may be present on the interface between first plant filler 2 or second plant filler 3 and base resin 1, and the like. First plant filler 2 is contained in an amount from 50 mass % to 97 mass % inclusive with respect to the amounts of first and second plant fillers 2, 3, and first plant filler 2 contains less than 1 mass % of triacylglycerol. Second plant filler 3 is contained in an amount from 3 mass % to 50 mass % inclusive with respect to the amounts of first and second plant fillers 2, 3, and second plant filler 3 contains from 1 mass % to 40 mass % inclusive of triacylglycerol 4. Base resin 1 is a crystalline resin.

Plant filler-containing composite resin composition 10 according to the first exemplary embodiment contains from 3 mass % to 50 mass % inclusive of second plant filler 3 containing from 1 mass % to 40 mass % inclusive of triacylglycerol 4, with respect to the total amount of first and second plant fillers 2, 3. Plant filler-containing composite resin composition 10 according to the first exemplary embodiment also contains from 50 mass % to 97 mass % inclusive of first plant filler 2 containing less than 1 mass % of triacylglycerol 4. For this reason, plant filler-containing composite resin composition 10 can have high fluidity while having high strength. Thus, a molding method having high mass productivity in a high cycle, such as injection molding or extrusion molding can be applied. In addition, since the crystalline resin is used for base resin 1, the degree of crystallinity around first and second plant fillers 2, 3 and the degree of crystallinity of the entire resin are increased, thereby making it possible suppress bleed-out of triacylglycerol 4. Therefore, a molded article using the plant filler-containing composite resin composition can be used as a molded article without any problem.

Hereinafter, each component constituting the plant filler-containing composite resin composition will be described.

<Base Resin>

Base resin 1 in the exemplary embodiment is preferably a crystalline resin in order to suppress the bleed-out of triacylglycerol, and more preferably a thermoplastic resin in order to ensure good moldability. Examples of the crystalline resin include olefin-based resins (including a cyclic olefin-based resin), polyamide-based resins, polyphenylene ether-based resins (such as a polymer of 2,6-xylenol), crystalline polyester-based resins, halogen-containing resins, and liquid crystal polymer resins. The above resins may be used alone or in combination of two or more types thereof. Note that the resin is not limited to the above materials as long as it has crystallinity. When two or more types of resins are used, at least one type of resin may have crystallinity.

Among these the crystalline resins, the base resin is preferably an olefin-based resin having a relatively low melting point. Examples of the olefin-based resin include a homopolymer of an olefin-based monomer, a copolymer of an olefin-based monomer, and a copolymer of an olefin-based monomer and another copolymerizable monomer. Examples of the olefin-based monomer include chain olefins (α-C2-20 olefin such as ethylene, propylene, 1-butene, isobutene, 1-pentene, 4-methyl-1-pentene and 1-octene, and the like) and cyclic olefins. These olefin-based monomers may be used alone or in combination of two or more types thereof. Among the olefin-based monomers, chain olefins such as ethylene and propylene are preferable. Specific examples of the olefin-based resin include copolymers of chain olefins (particularly α-C2-4 olefin) such as polyethylene (low density, medium density, high density or linear low density polyethylene, etc.), polypropylene, an ethylene-propylene copolymer, and a terpolymer such as ethylene-propylene-butene-1.

Base resin 1 is preferably a crystalline resin. Crystalline portion 12 has a denser structure than amorphous portion 11. Therefore, in crystalline portion 12, the diffusion rate of liquid, gas, or the like is significantly reduced as compared with amorphous portion 11. Since triacylglycerol diffuses in the composite resin as a liquid component, the diffusion rate of triacylglycerol is greatly reduced in crystalline portion 12 as compared with amorphous portion 11. The presence of crystalline portion 12 in the resin reduces the diffusion rate of the liquid, thereby making it possible to suppress the bleed-out of triacylglycerol from the composite resin composition. Therefore, base resin 1 is preferably a crystalline resin.

The degree of crystallinity of base resin 1 is preferably more than or equal to 30%, and more preferably more than or equal to 60%. When the degree of crystallinity of base resin 1 is less than 30%, the bleed-out of triacylglycerol cannot be suppressed so much because the proportion of the amorphous portion is large. Therefore, the degree of crystallinity of base resin 1 is preferably within the above range.

Base resin 1 may include a first region around the plant filler, and a second region away from the plant filler. The degree of crystallinity of base resin 1 in the first region is preferably more than or equal to 1.05 times, more preferably more than or equal to 1.10 times the degree of crystallinity of base resin 1 in the second region. When the degree of crystallinity of the base resin in the first region is too low, the resin around the plant filler cannot form a dense structure. That is, triacylglycerol cannot be maintained around the plant filler, thus failing to suppress the bleed-out to the surface of the composite resin. Therefore, the degree of crystallinity of base resin 1 in the first region is preferably within the above range as compared with the degree of crystallinity of base resin 1 in the second region.

<First Plant Filler>

Examples of the raw material of first plant filler 2 containing less than a certain amount of triacylglycerol in the exemplary embodiment include natural materials such as pulp, wood (softwood, hardwood), cotton linter, kenaf, Manila hemp (abaca), sisal hemp, jute, sabai grass, esparto grass, and bagasse. In addition, a natural material modified with a functional monomer containing an acid, an amine, an epoxy, or the like may be used. First plant filler 2 is preferably a fibrous or particulate filler obtained by pulverizing the above natural material.

The total amount of cellulose, hemicellulose, and lignin in first plant filler 2 containing less than 1 mass % of triacylglycerol is preferably more than or equal to 80 mass %, and more preferably more than or equal to 90%. Cellulose, hemicellulose, and lignin are components that form the skeleton of the plant, and the strength of the plant greatly depends on the amounts of these three components. When the total amount of cellulose, hemicellulose, and lignin in first plant filler 2 is less than 80 mass %, the strength of the first plant filler is reduced, so that the strength as a composite resin is also reduced. Therefore, the total amount of cellulose, hemicellulose, and lignin in first plant filler 2 is preferably within the above range.

<Second Plant Filler>

Examples of the raw material of second plant filler 3 containing a certain amount or more of triacylglycerol in the exemplary embodiment include natural materials such as beans, wheat, barley, rice, and coffee beans. From the viewpoint of environment and cost, plant waste materials discarded after commercial use, such as coffee bean grounds after coffee brewing may be used. Second plant filler 3 is preferably a fibrous or particulate material obtained by pulverizing the above material.

In second plant filler 3, the content of the triacylglycerol is preferably from 1 mass % to 40 mass % inclusive, and more preferably from 3 mass % to 30 mass % inclusive. When the content of the triacylglycerol is less than 1 mass %, the amount of the triacylglycerol is too small, thus failing to improve the fluidity of the composite resin composition. When the content of the triacylglycerol is more than 40 mass %, the amount of the triacylglycerol having low strength properties is too large. Thus, the strength properties of the plant filler are deteriorated, and the mechanical strength of the plant filler-containing composite resin composition is significantly deteriorated. Therefore, in second plant filler 3, the content of the triacylglycerol is preferably from 1 mass % to 40 mass % inclusive, and more preferably from 3 mass % to 30 mass % inclusive.

The content of second plant filler 3 is preferably from 3 mass % to 50 mass % inclusive, and more preferably from 5 mass % to 30 mass % inclusive with respect to the total amount of first plant filler 2 and second plant filler 3. When the content of second plant filler 3 is less than 3 mass % with respect to the total amount of the plant fillers, the amount of the triacylglycerol is too small, failing to improve the fluidity sufficiently. When the content is more than 50 mass %, the amount of second plant filler 3 having weaker strength than that of first plant filler 2 is large. Thus, the reinforcing effect of the plant filler is reduced, resulting in decrease in the mechanical strength of the composite resin composition. Therefore, the content of second plant filler 3 is preferably from 3 mass % to 50 mass % inclusive, and more preferably from 5 mass % to 30 mass % inclusive with respect to the total amount of first plant filler 2 and second plant filler 3.

The total amount of the plant fillers of first and second plant fillers 2, 3 in the composite resin composition is preferably from 50 mass % to 90 mass % inclusive, and more preferably from 55 mass % to 85 mass % inclusive. As shown in FIG. 1, the composite resin composition according to the present exemplary embodiment contains base resin 1, first plant filler 2, second plant filler 3, triacylglycerol 4, and dispersant 5. The mechanical strength of the plant filler increases as the addition amount thereof increases. In addition, since the bio degree increases as the components of the plant-derived material increase, there is an effect of reducing the environmental load, such as carbon neutral. When the amount of the plant filler is less than 50 mass %, the effect of reinforcing the resin by the plant filler is reduced, so that the mechanical strength of the composite resin is reduced. In addition, since the bio degree is also reduced, the effect of reducing the environmental load is reduced. When the amount of the plant filler is more than 90 mass %, the amount of the resin is too small. Thus, the fluidity of the composite resin is significantly reduced, failing to stably perform kneading and molding. In addition, since the amount of the resin is too small as compared with the amount of the plant filler, first plant filler 2 and second plant filler 3 cannot be included in base resin 1. As a result, a large amount of the first and second plant fillers are exposed on the resin surface, failing to suppress the bleed-out of triacylglycerol. Therefore, the amount of the plant filler in the composite resin composition is preferably within the above range.

The average particle size of the first and second plant fillers is preferably from 100 nm to 3 mm inclusive. When the average particle size is less than 100 nm, the size of the first and second plant fillers is small, and the surface area per filler is too large. As a result, the viscosity of the composite resin is too high, and the fluidity is too low, and therefore more than or equal to 50% of the filler cannot be added. When the average particle size is more than 3 mm, the plant filler cannot be uniformly dispersed in the resin, and the variation in strength in the composite resin composition is also increased, resulting in unstable quality. Therefore, the average particle size of the plant filler is preferably within the above range.

<Triacylglycerol>

Triacylglycerol 4 in the exemplary embodiment is preferably a component derived from a natural material or a component generated by alteration of the component derived from the natural material in the production process of the material. Examples of the triacylglycerol include tripalmitin, and 1-linoleoyl-2-palmitoleoyl-3-stearoylglycerol. The triacylglycerol is not limited to the above components as long as it is a component contained in the plant filler.

Triacylglycerol 4 is preferably derived from the plant filler. When triacylglycerol is separately added, all the triacylglycerols are present in the resin from the initial stage of kneading of the raw materials. Thus, the viscosity is low, and shear stress cannot be applied strongly, failing to disperse and fibrillate plant fillers well. Therefore, triacylglycerol 4 of the present disclosure is preferably derived from the above plant fillers.

The amounts of base resin 1, first plant filler 2, second plant filler 3, and dispersant 5 in the composite resin composition are 100 mass % in total. Since triacylglycerol 4 is contained in first plant filler 2 and second plant filler 3, the amount of triacylglycerol 4 is included in the amounts of first plant filler 2 and second plant filler 3.

<Dispersant>

Examples of dispersant 5 in the exemplary embodiment include various titanate-based coupling agents, silane coupling agents, modified polyolefins obtained through graft modification with unsaturated carboxylic acid, maleic acid, maleic anhydride, or an anhydride thereof, fatty acids, fatty acid metal salts, and fatty acid esters. The silane coupling agent is preferably an unsaturated hydrocarbon-based silane coupling agent or an epoxy-based silane coupling agent. The surface of the dispersant may be treated and modified with a thermosetting or thermoplastic polymer component. Dispersant 5 is appropriately selected by a combination of base resin 1, first plant filler 2, and second plant filler 3.

<Method for Producing Composite Resin Composition>

In the method for producing a composite resin composition according to the first exemplary embodiment, a composite resin composition can be obtained by preparing the base resin, the first plant filler, the second plant filler, and the dispersant so as to have a predetermined mass ratio, and then kneading the components.

The kneading apparatus used in the method for producing a composite resin composition is preferably a kneader, a Banbury mixer, an extruder, and a roll kneader. Among them, it is more preferable to use a twin screw kneader and a roll kneader. The kneading apparatus is not limited to the above apparatus as long as the kneading apparatus includes a rotating body as a kneading means. In addition, since the components in the plant filler are components easily decomposed by heat and volatile components, kneading is preferably performed at as low temperature as possible.

### EXAMPLES

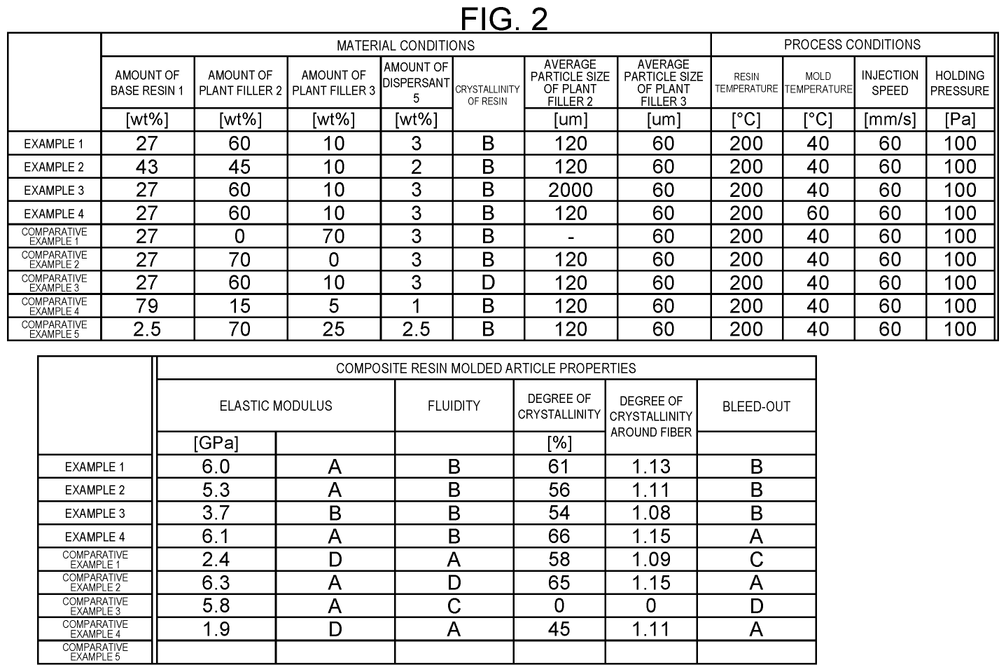

FIG. 2 shows conditions and measurement results of Examples 1 to 4 and Comparative Examples 1 to 5.

A plant filler-containing composite resin composition was produced by the following production method. As described above, a kneader, a Banbury mixer, an extruder, a roll kneader, or the like can be used as the kneading apparatus, but a twin screw kneader was used in Examples.

Polypropylene as the base resin, pulverized pulp and coffee bean grounds as the plant filler, and maleic anhydride-modified polypropylene as the dispersant were weighed at a mass ratio of 27:60:10:3, and dry-blended. Softwood pulp (product name: NBKP Celgar, manufactured by Mitsubishi Paper Mills Limited.) was used as a starting material for the pulverized pulp. The softwood pulp was pulverized with a pulverizer to obtain a fibrous filler as the pulverized pulp. The filler size was adjusted in the pulverization process.

The dry-blended mixture was melt-kneaded and dispersed with a twin screw kneader (KRC kneader, manufactured by Kurimoto, Ltd.). The shearing force can be changed by changing the screw configuration of the twin screw kneader. In Example 1, a low-shear type specification was adopted. The composite resin discharged from the twin screw kneader was hot-cut to prepare plant filler-containing composite resin pellets.

A test piece of a composite resin molded article was prepared using the prepared plant filler-containing composite resin pellets by an injection molding machine (180AD, manufactured by The Japan Steel Works, LTD.). The preparation conditions of the dumbbell test piece were a resin temperature of 200° C., a mold temperature of 40° C., an injection speed of 60 mm/s, and a holding pressure of 100 MPa. The pellets were bit by the screw of the molding machine via the hopper, and the biting performance at that time was measured as the amount of decrease in the pellet per hour, and it was confirmed that the biting performance was constant. The shape of the test piece was changed according to the evaluation items described below, and a No. 1 size dumbbell test piece was prepared for measuring the elastic modulus. In addition, a spiral flow test piece having a spiral shape was prepared for evaluating the fluidity. The obtained test pieces of the plant filler-containing composite resin molded article were evaluated by the following method.

[Evaluation Items of Composite Resin Molded Article]

(Elastic Modulus of Composite Resin Molded Article)

A three-point bending test was performed using the obtained No. 1 dumbbell-shaped test piece. Herein, as a method for evaluating the elastic modulus, a sample having a numerical value of less than 3.0 GPa was evaluated as D, a sample having a numerical value of more than or equal to 3.0 GPa and less than 3.5 GPa was evaluated as C, a sample having a numerical value of more than or equal to 3.5 GPa and less than 5.0 GPa was evaluated as B, and a sample having a numerical value of more than or equal to 5.0 GPa was evaluated as A. The test piece had an elastic modulus of 6.0 GPa, and the evaluation thereof was A.

(Fluidity Evaluation of Composite Resin)

The length of the obtained spiral flow test piece having a spiral shape was measured. A case where the loading length of test piece was less than 30% of the entire length of the spiral flow was evaluated as D, a case where the loading length was more than or equal to 30% and less than 50% was evaluated as C, a case where the loading length was more than or equal to 50% and less than 70% was evaluated as B, and case where the loading length was more than or equal to 70% was evaluated as A. The length of the test piece was 63%, and the evaluation thereof was B.

(Degree of Crystallinity of Composite Resin)

The melting (crystallization) peak was measured by differential scanning calorimetry (DSC), and the heat of fusion was calculated. The degree of crystallinity was calculated by the following formula.

Degree of crystallinity=(measured heat of fusion/heat of fusion of perfect crystal)×100

Here, as a method for evaluating the degree of crystallinity, a sample having a degree of crystallinity of less than 30% was evaluated as D, a sample having a degree of crystallinity of more than or equal to 30% and less than 60% was evaluated as B, and a sample having a degree of crystallinity of more than or equal to 60% was evaluated as A. The composite resin had a degree of crystallinity of 61%, and the evaluation thereof was A.

(Degree of Crystallinity Around Fiber)

A part of the obtained No. 1 dumbbell-shaped test piece was cut out and observed by Raman spectroscopy. A sample in which the degree of crystallinity of the resin around the plant filler was less than 1.05 times the degree of crystallinity of the portion composed of only crystals was evaluated as D, and a sample in which the degree of crystallinity was more than or equal to 1.05 times was evaluated as B. The degree of crystallinity of the test piece was 1.13 times, and the evaluation thereof was B.

(Evaluation Results of Triacylglycerol Bleed-Out)

A bleed-out evaluation test of triacylglycerol was performed using the obtained No. 1 dumbbell-shaped test piece. The test piece is usually left under normal temperature conditions, but was placed in a small hot air dryer at 60° C. in order to perform an accelerated test, and whether the surface of the test piece was sticky or not was confirmed every 24 hours. Regarding the sticky test piece, the test piece was placed in a solvent capable of dissolving triacylglycerol, and component analysis of the solvent was performed to confirm whether the bleed-out component was triacylglycerol. The test in an environment in which hot air at 60° C. is blown is an accelerated test of about 50 times the test in a normal atmosphere at normal temperature. A sample in which bleed-out occurred in less than 48 hours was evaluated as D, a sample in which bleed-out occurred in more than or equal to 48 hours and less than 72 hours was evaluated as C, a sample in which bleed-out occurred in more than or equal to 72 hours and less than 96 hours was evaluated as B, and a sample in which bleed-out occurred in more than or equal to 96 hours was evaluated as A. The test piece was evaluated as B.

### Example 2

In Example 2, the amount of the plant filler was reduced, and the mass ratio of the base resin:pulverized pulp:coffee bean grounds:dispersant was changed to 43:45:10:2. A plant fiber-containing composite resin pellet and a molded article were prepared under the same conditions as in Example 1 except for the above. The evaluation was performed in the same manner as in Example 1.

### Example 3

In Example 3, a pulverized pulp having an average particle size of 2 mm, which was larger than that in Example 1, was used as the plant fiber. A cellulose fiber-containing composite resin pellet and a molded article were prepared under the same material conditions and process conditions as in Example 1 except for the above. The evaluation was performed in the same manner as in Example 1.

### Example 4

In Example 4, injection molding conditions were changed so that the mold temperature during injection molding was higher than that in Example 1. A cellulose fiber-containing composite resin pellet and a molded article were prepared under the same material conditions and process conditions as in Example 1 except for the above. The evaluation was performed in the same manner as in Example 1.

### Comparative Example 1

In Comparative Example 1, only coffee grounds were used as the plant filler, and the mass ratio of the base resin:pulp:coffee bean grounds:dispersant was changed to 27:0:70:3. A composite resin pellet and a molded article were prepared under the same material conditions and process conditions as in Example 1 except for the above. The evaluation was performed in the same manner as in Example 1.

### Comparative Example 2

In Comparative Example 2, only pulp was used as the plant filler, and the mass ratio of the base resin:pulp:coffee bean grounds:dispersant was changed to 27:70:0:3. A composite resin pellet and a molded article were prepared under the same material conditions and process conditions as in Example 1 except for the above. The evaluation was performed in the same manner as in Example 1.

### Comparative Example 3

In Comparative Example 3, a cellulose fiber-containing composite resin pellet and a molded article were prepared under the same material conditions and process conditions as in Example 1 except that PS, which is an amorphous resin, was used as the base resin. The evaluation was performed in the same manner as in Example 1.

### Comparative Example 4

In Comparative Example 4, the amount of the plant fiber was reduced as compared with Example 1, and the mass ratio of the base resin:pulp:coffee bean grounds:dispersant was changed to 79:15:5:1. A plant fiber-containing composite resin pellet and a molded article were prepared under the same material conditions and process conditions as in Example 1 except for the above. The evaluation was performed in the same manner as in Example 1.

### Comparative Example 5

In Comparative Example 5, the amount of the plant filler was increased as compared with Example 1, and the weight ratio of the base resin:pulp:coffee bean grounds:dispersant was changed to 2.5:70:25:2.5. A plant filler-containing composite resin pellet and a molded article were prepared under the same material conditions and process conditions as in Example 1 except for the above. The evaluation was performed in the same manner as in Example 1.

The measurement results in respective Examples 1 to 4 and Comparative Examples 1 to 5 are shown in the table of FIG. 3.

In Example 2 in which the amount of the plant filler was reduced, the reinforcing effect by the plant filler was reduced as compared with Example 1, so that the elastic modulus was 5.3 GPa. The degree of crystallinity decreased to 56% due to decrease in the amount of the plant filler.

In Example 3 in which a pulverized pulp having an average particle size of 2 mm was used, the particle size was larger and the surface area was reduced as compared with Example 1, so that the reinforcing effect was reduced and the elastic modulus was 3.7, and the evaluation result was B.

In Example 4 in which the mold temperature during injection molding was high, the composite resin was slowly cooled as compared with Example 1, so that the degree of crystallinity increased to 66%, and the evaluation result was A.

In Comparative Example 1 in which only coffee grounds were used as the plant filler, the reinforcing effect of the plant filler on the resin was small, the elastic modulus was 2.4 GPa, and the evaluation result was D.

In Comparative Example 2 in which only pulp was used as the plant filler, the fluidity was low, and the result of fluidity evaluation was D.

In Comparative Example 3 in which PS as an amorphous resin was used as the base resin, bleed-out of triacylglycerol could not be suppressed because there was no crystalline component of the resin, and the result of bleed-out evaluation was D.

In Comparative Example 4 in which the weight ratio of the plant fiber to the entire raw materials was reduced, the amount of the plant filler was small, so that the reinforcing effect of the filler on the composite resin was small, and the elastic modulus was 1.9 GPa.

In Comparative Example 5 in which the weight ratio of the plant fiber to the entire raw materials was increased, the amount of the plant filler was large and the amount of the resin was too small, so that the viscosity of the composite resin was too high, the load on the apparatus was large, and kneading and molding could not be stably performed. Therefore, a test piece could not be prepared, and thus evaluation could not be performed.

From the above evaluations, when only the second plant filler containing from 1 mass % to 40 mass % inclusive of triacylglycerol was used, the strength of the composite resin did not reach the required level. Meanwhile, when only the first plant filler containing less than 1 mass % of triacylglycerol was used, the fluidity was low, thus failing to stably mold a complex shape such as a product shape. In addition, when the amorphous resin was used as the base resin, bleed-out of triacylglycerol could not be suppressed. Further, when the plant filler concentration was lowered, the amount of the plant filler was small, so that the reinforcing effect was reduced, and the strength of the composite resin was reduced. On the other hand, when the plant filler concentration was too high, kneading and molding could not be stably performed. The above results show that when the plant filler containing triacylglycerol and the crystalline resin are used and the content of the plant filler is from 50 mass % to 90 mass % inclusive, the composite resin composition can be stably produced, has high mechanical strength, and can have high fluidity.

Note that the present disclosure includes an appropriate combination of any exemplary embodiment and/or example among the various above-described exemplary embodiments and/or examples, and effects of each of the exemplary embodiments and/or examples can be achieved.

### INDUSTRIAL APPLICABILITY

According to the composite resin composition according to one aspect of the present disclosure, it is possible to provide an environmentally friendly molded article which is more excellent in mechanical strength than conventional general-purpose resins, and has a high bio degree with a plant filler content of more than or equal to 50 mass %. The composite resin composition according to one aspect of the present disclosure has high fluidity without separately adding a plasticizer. Thus, a molded article can be obtained by a molding method having high mass productivity in a high cycle, such as injection molding or extrusion molding. Therefore, the composite resin molded article according to one aspect of the present disclosure can be used for housings of household electric appliances, building materials, and automobile components that require excellent mechanical strength and high productivity.

### REFERENCE MARKS IN THE DRAWINGS

1 base resin
2 first plant filler
3 second plant filler
4 triacylglycerol
5 dispersant
10 plant filler-containing composite resin composition
11 amorphous portion
12 crystalline portion

1. A plant filler-containing composite resin composition comprising:
a base resin;
a plant filler dispersed in the base resin; and
a dispersant dispersed in the base resin, wherein
from 50 mass % to 97 mass % inclusive of the plant filler is a first plant filler containing less than 1 mass % of triacylglycerol,
from 3 mass % to 50 mass % inclusive of the plant filler is a second plant filler containing from 1 mass % to 40 mass % inclusive of triacylglycerol, and
the base resin is a crystalline resin.

2. The plant filler-containing composite resin composition according to claim 1, wherein a content of the plant filler in the plant filler-containing composite resin composition ranges from 50 mass % to 90 mass % inclusive when a total amount of the base resin, the plant filler, and the dispersant in the plant filler-containing composite resin composition is 100 mass %.

3. The plant filler-containing composite resin composition according to claim 1, wherein in the second plant filler, a total content of cellulose, hemicellulose, and lignin is from 5 mass % to 50 mass % inclusive.

4. The plant filler-containing composite resin composition according to claim 1, wherein in the first plant filler, a total content of cellulose, hemicellulose, and lignin is more than or equal to 80 mass %.

5. The plant filler-containing composite resin composition according to claim 1, wherein the plant filler has an average particle size of from 100 nm to 3 mm inclusive.

6. The plant filler-containing composite resin composition according to claim 1, wherein the base resin has a degree of crystallinity of more than or equal to 30%.

7. The plant filler-containing composite resin composition according to claim 1, wherein
the base resin includes a first region around the plant filler, and a second region away from the plant filler, and
a degree of crystallinity of the base resin in the first region is more than or equal to 1.05 times a degree of crystallinity of the base resin in the second region.

8. A composite resin molded article comprising the plant filler-containing composite resin composition according to claim 1.
